(19) United States
(12) Patent Application Publication
(10) Pub. No.: US 2009/0311499 A1
(43) Pub. Date: Dec. 17, 2009

(54) ALL NATURAL ANTIMICROBIAL CARPET CUSHION AND METHOD OF MANUFACTURE

(75) Inventors: Harry R. Hickey, Macomb, MI (US); David H. Johnson, Elkhart, IN (US)

Correspondence Address: BARNES & THORNBURG LLP, 600 ONE SUMMIT SQUARE, FORT WAYNE, IN, 46802, US

(73) Assignee: Flexform Technologies, LLC, Elkhart, IN (US)

(21) Appl. No.: 12/484,620

(22) Filed: Jun. 15, 2009

Related U.S. Application Data
(60) Provisional application No. 61/061,450, filed on Jun. 13, 2008.

(51) Int. Cl. B32B 5/00; B32B 5/02; D04H 1/46

(52) U.S. Cl. 428/219; 442/123; 442/60; 28/103

(57) ABSTRACT

The present disclosure describes natural antimicrobial carpet pads that are flexible and resilient sheets of predominantly natural plant fibers and/or animal fibers. These fibers have been subjected to a nonwoven needling process to form a mat. An antimicrobial material is intermixed with the plant and animal fibers. The antimicrobial material may also serve as a bonding agent for the fibers.

### RELATED APPLICATIONS

The present application is related to and claims priority to U.S. Provisional Patent Application Ser. No. 61/061,450, filed on Jun. 13, 2008, entitled All Natural Antimicrobial Carpet Cushion and Method of Manufacture. The subject matter disclosed in that provisional application is hereby expressly incorporated into the present application by reference.

### TECHNICAL FIELD

The present disclosure relates underlayment for carpeting. More particularly, this disclosure describes a natural antimicrobial carpet pad underlayment and methods for making the same.

### BACKGROUND AND SUMMARY

Carpet padding is typically made of polyurethane foam pieces bonded together to form a large thick sheet. This sheet is placed on top of the flooring and underneath the carpet. Being sandwiched between the carpet and the floor adds cushioning to the carpet surface.

The present disclosure departs from the traditional foam pad by describing an all-natural carpet pad. The pad is made from natural fibers such as plant and animal fibers that are treated with an antimicrobial material.

An illustrative embodiment of the present disclosure includes a natural antimicrobial carpet pad that comprises a flexible and resilient sheet of predominantly natural plant fibers and animal fibers. These fibers have been subjected to a nonwoven needling process. An antimicrobial material is intermixed with the plant and animal fibers.

The above and other illustrative embodiments may also comprise: the antimicrobial material having bonding characteristics causing the antimicrobial material to bond with the plant and animal fibers; the plant fibers being selected from a group consisting of tossa, kenaf, hemp, flax, and cotton; the animal fibers being wool; the sheet being composed of about 78% natural fiber and about 20% wool, and the balance being the antimicrobial material; the antimicrobial material being disodium octaborate tetrahydrate; the plant fibers having a length of about 35 to about 215 mm; the animal fibers having a length of about 35 to about 85 mm; the plant and animal fibers and the antimicrobial material being distributed uniformly throughout the sheet; the sheet having a weight of about 1400 gsm and being about 8 mm thick; the sheet having a density of about 0.175 g/cc; the plant and animal fibers being mechanically locked together; and the antimicrobial material being homogeneously distributed throughout the mat.

Another illustrative embodiment of the present disclosure includes a natural antimicrobial carpet pad that comprises a flexible and resilient sheet of predominantly natural plant fibers. Also included is an antimicrobial material intermixed with the plant fibers.

A further illustrative embodiment of the present disclosure includes a process of manufacturing a natural antimicrobial carpet pad, comprising the steps of: interlocking plant and animal fibers into a fiber matrix by a process of nonwoven needling; forming a carpet pad structure from the needling process; applying an antimicrobial material on and in the carpet pad structure; and drying the antimicrobial material which provides both binding and antimicrobial material properties to the pad.

The above and other illustrative embodiments may also comprise the steps of: providing a slurry of water and disodium octaborate tetrahydrate as the antimicrobial material; spraying the slurry onto and in the pad; spraying the fibers during forming of carpet pad; and evaporating the water and leaving the sodium octaborate tetrahydrate fixing the fibers together.

Additional features and advantages of the antimicrobial carpet padding will become apparent to those skilled in the art upon consideration of the following detailed description of the illustrative embodiments exemplifying the best mode of carrying out the carpet pad as presently perceived.

Further, the abstract and background of this disclosure is provided to enable the U.S. Patent and Trademark Office, those skilled in the art, and the public at large (including those whom are not familiar with patent or legal terms or phraseology, or necessarily versed in the relevant art) to determine from a cursory inspection the nature of the subject matter in this disclosure.

### BRIEF DESCRIPTION OF THE DRAWINGS

The present disclosure will be described hereafter with reference to the attached drawings which are given as non-limiting examples only, in which:

FIG. 1 is a side view of a carpet and an illustrative embodiment of a carpet pad according to the present disclosure; and

FIG. 2 is a flow chart depicting an illustrative embodiment of the manufacturing process of an antimicrobial carpet pad.

Corresponding reference characters indicate corresponding parts throughout the several views. The exemplification set out herein illustrates embodiments of the antimicrobial carpet pad, and such exemplification is not to be construed as limiting the scope of the antimicrobial carpet pad.

### DETAILED DESCRIPTION OF THE DISCLOSURE

The present disclosure is directed to a natural antimicrobial carpet pad and particularly to a fiber pad that suppresses microbial growth in homes, offices and other dwellings. Foam bases are not used in this pad, in contrast to the prior art. Rather, the present disclosure uses a natural fiber such as a bast fiber-based pad. One embodiment includes a pad made from nonwoven randomly-oriented natural fibers such as tossa, kenaf, hemp, flax, and cotton. Another embodiment includes needling these fibers along with animal fibers such as wool. An antimicrobial mineral powder, such as a borate mineral, is combined in the nonwoven matrix. Borate compounds have antimicrobial, insecticidal, fire retardant, and odor controlling functions. Borate compounds counteract the odor and microbe growth from urine in a carpet pad. In an illustrative embodiment, the product uses no man-made chemicals.

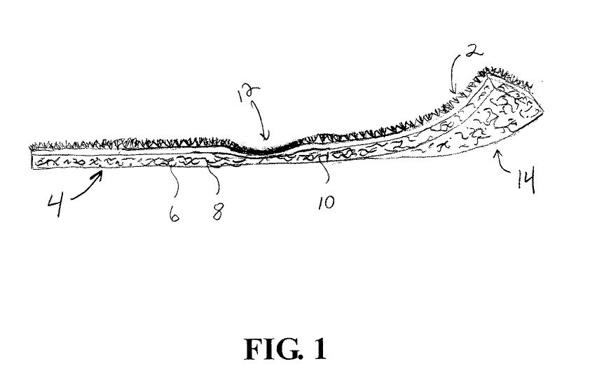

A side view showing a carpet 2 on a flexible and resilient carpet pad 4 is shown in FIG. 1. Carpet pad 4 is illustratively made from plant fiber 6 and animal fiber 8. Antimicrobial material 10 is also dispersed throughout padding 4. This padding 4 is also shown as resilient, as indicated by reference numeral 12, and is flexible, as shown by reference numeral 14.

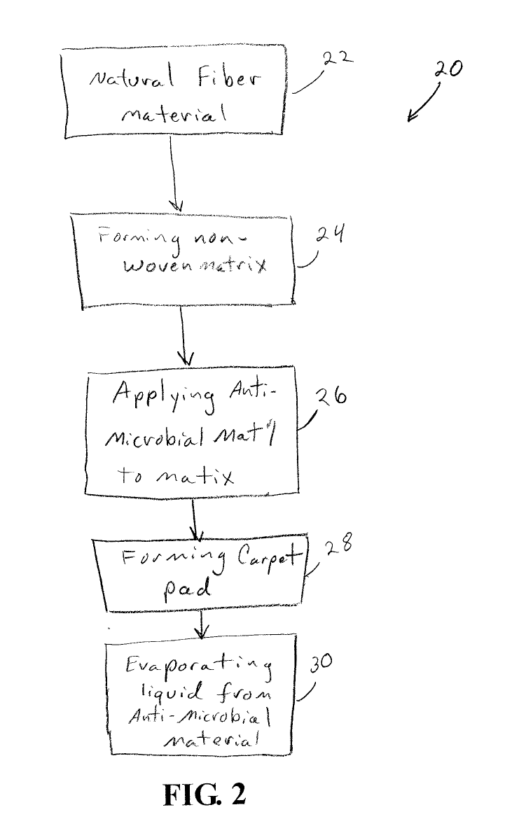

A flow chart 20 depicting an illustrative process for making the natural antimicrobial carpet pad is shown in FIG. 2. First, natural fibers are provided at 22. The natural fibers are illustratively plant and animal fibers about 35 to 215 mm for plant fibers and about 35 to 85 mm for animal fibers. A matrix is formed at 24 by interlocking the fibers using a process of continuous nonwoven needling, for example. Applying the antimicrobial material to the matrix is identified by reference number 26. Disodium octaborate tetrahydrate is naturally sticky in the presence of water, and dries to a bonded state with the fibers. The water is used as a liquid slurry carrier and as a partial solvent for applying the disodium octaborate tetrahydrate to the fiber matrix. In an illustrative embodiment, the antimicrobial slurry is sprayed onto the fiber mat. In another illustrative embodiment, the spray is applied during the creation of the fiberous web in a continuous non-woven needling loom. This forms the carpet pad as indicated by reference numeral 28. The water is subsequently evaporated leaving the sodium octaborate tetrahydrate fixed in the fiber matrix as indicated by reference number 30. A downstream drying oven can be set to about 120° C., which by feel, dries the mat.

The following examples are for illustrative purposes and are not intended to be limiting.

### Examplary Formulation

About 78% natural fiber;

about 20% wool;

about 2% Boron Sodium Oxide (B₈NA₂O₁₃), Tetrahydrate also known as disodium octaborate tetrahydrate;

the natural fiber is of fiber length of about 35 to 215 mm;

the wool fiber is of fiber length of about 35 to 85 mm;

the disodium octaborate tetrahydrate is in the form of both molecule and fine powder, trade names for disodium octaborate tetrahydrate include “Polybor” and “Octabor” from Rio Tinto minerals;

the ingredients are uniformly distributed throughout a mat;

an illustrative mat can weigh about 1400 gsm and be approximately 8 mm thick;

an illustrative density of the mat can be about 0.175 g/cc;

the fibers are mechanically locked together; and

the disodium octaborate tetrahydrate powder is fixed by natural chemical bonding, by absorption and by mechanical interlocking within the fiber matrix.

### Examplary Process

The fibers are interlocked into a fiber matrix by a process of continuous nonwoven needling, wherein the weight of the pad is about 1400 gsm, and the needling is about 50-55 punches per square inch;

disodium octaborate tetrahydrate is mixed with water at the rate of about 11 pounds per 4 gallons of water, which results in about a 25% solution;

the water was about 93° F. (34° C.) at the hot water tap to keep the borate dissolved;

the disodium octaborate tetrahydrate is applied using a sprayer, for example, so when dry, it bonds with the other fibers;

the spray manifold is illustratively regulated to about 24 psi air and about 19 psi liquid, which delivers about 11.7 gallons per hour;

an illustrative distance from the spray nozzles to junction of upper and lower web is about 2 feet, the extreme back position of the mounting device;

the nonwoven fiber production line is run at about 2.52 mps which along with the delivery rate yields about 2% borate;

the downstream drying oven is set at about 120° C. (The spray adds about 6% moisture, along with the about 2% borate.); and

water is evaporated leaving the sodium octaborate tetralhydrate fixed in the fiber matrix.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed:

1. A natural antimicrobial carpet pad, comprising:
a flexible and resilient sheet of predominantly natural plant fibers and animal fibers subjected to nonwoven needling; and
an antimicrobial material intermixed with the plant and animal fibers.

2. The natural antimicrobial carpet pad of claim 1, wherein the antimicrobial material has bonding characteristics causing the antimicrobial material to bond with the plant and animal fibers.

3. The natural antimicrobial carpet pad of claim 1, wherein the plant fibers are selected from a group consisting of tossa, kenaf, hemp, flax, and cotton.

4. The natural antimicrobial carpet pad of claim 3, wherein the animal fibers are wool.

5. The natural antimicrobial carpet pad of claim 4, wherein the sheet is composed of about 78% natural fiber and about 20% wool, and the balance the antimicrobial material.

6. The natural antimicrobial carpet pad of claim 1, wherein the antimicrobial material is disodium octaborate tetrahydrate.

7. The natural antimicrobial carpet pad of claim 5, wherein the plant fiber length is about 35 to about 215 mm.

8. The natural antimicrobial carpet pad of claim 5, wherein the animal fiber length is about 35 to about 85 mm.

9. The natural antimicrobial carpet pad of claim 1, wherein the plant and animal fibers and the antimicrobial material are distributed uniformly throughout the sheet.

10. The natural antimicrobial carpet pad of claim 1, wherein the sheet has a weight of about 1400 gsm and is about 8 mm thick.

11. The natural antimicrobial carpet pad of claim 1, wherein the sheet has a density of about 0.175 g/cc.

12. The natural antimicrobial carpet pad of claim 1, wherein the plant and animal fibers are mechanically locked together.

13. The pad of claim 1, wherein the antimicrobial material is homogeneously distributed throughout the mat.

14. A natural antimicrobial carpet pad comprising:
a flexible and resilient sheet of predominantly natural plant fibers subjected to nonwoven needling; and
an antimicrobial material intermixed with the plant fibers.

15. A process of manufacturing a natural antimicrobial carpet pad, comprising the steps of:
interlocking plant and animal fibers into a fiber matrix by a process of nonwoven needling;
forming a carpet pad structure from the needled fibers;
applying an antimicrobial material on and in the carpet pad structure; and
drying the antimicrobial material which provides both binding and antimicrobial material properties to the pad.

16. The method of claim 15, further comprising the step of providing a slurry of water and disodium octaborate tetrahydrate as the antimicrobial material.

17. The method of claim 16, further comprising the step of spraying the slurry onto and in the pad.

18. The method of claim 17 further comprising the step of spraying the fibers during forming of carpet pad.

19. The method of claim 18 further comprising the step of evaporating the water and leaving the sodium octaborate tetrahydrate fixing the fibers together.
